(19) United States
(12) Patent Application Publication
(10) Pub. No.: US 2011/0302264 A1
(43) Pub. Date: Dec. 8, 2011

(54) RFID NETWORK TO SUPPORT PROCESSING OF RFID DATA CAPTURED WITHIN A NETWORK DOMAIN

(75) Inventors: CALVIN D. LAWRENCE, ATLANTA, GA (US); JOHN W. MILLER, SUWANEE, GA (US)

(73) Assignee: INTERNATIONAL BUSINESS MACHINES CORPORATION, ARMONK, NY (US)

(21) Appl. No.: 12/791,922

(22) Filed: Jun. 2, 2010

(51) Int. Cl. G06F 17/30; G06F 15/16

(52) U.S. Cl. 709/207; 707/740; 707/E17.09

(57) ABSTRACT

RFID data can be received by a RFID data mediation service operating upon a RFID network data server. The received RFID data can be categorized based upon contents of at least one of a data store containing previously categorized RFID data and at least one categorization parameter associated with a data processing software application registered with the RFID data mediation service. The categorized RFID data can be stored in said data store. At least one record of categorized RFID data can be provided to a corresponding registered data processing software application. In one embodiment, the RFID network data server can provide software services to different entities for a fee, where each of the software services permits a software system of the different entities to react events triggered by the received RFID data in accordance with entity specific configurations established for the RFID network data service.

### BACKGROUND

The present invention relates to the field of RFID tag services and, more particularly, to an RFID network to support processing of RFID data captured within a network domain.

Radio frequency identification (RFID) tags are becoming a popular means for identifying and tracking a variety of items. RFID tags are also used as portable data storage for security, such as access control to a secured facility. As RFID tags become more integrated in daily life, RFID readers will be increasingly bombarded with RFID data.

Most of the RFID data bombarding a RFID reader will be extraneous to its function. For example, a RFID reader for controlling door access will receive RFID data from the RFID tag in a cell phone as a person passes through the door. The RFID data of the cell phone is useless to the RFID reader for the door. However, that RFID data could be useful for other purposes.

Currently, this extraneous data is ignored. There is a lack of infrastructure for capturing such data. For example, most conventional RFID systems are proprietary in nature and stove-piped from other RFID systems. Even instances where the extraneous data (i.e., data not specifically needed for a purpose of a proprietary system that performed the RFID reading) is captured, the RFID data is still meaningless to the capturing system. Conventional systems discard this “extraneous data”.

### SUMMARY

One aspect of the present invention can include a method, a system, a service, and a computer program product for providing categorized RFID data to data processing software applications. RFID data can be received by a RFID data mediation service operating upon a RFID network data server. The received RFID data can be categorized based upon contents of at least one of a data store containing previously categorized RFID data and at least one categorization parameter associated with a data processing software application registered with the RFID data mediation service. The categorized RFID data can be stored in said data store. At least one record of categorized RFID data can be provided to a corresponding registered data processing software application. In one embodiment, the RFID network data server can use a publish/subscribe methodology for receiving and providing RFID data received from different RFID readers at different geographic locations. In one embodiment, the RFID network data server can provide software services to different entities for a fee, where each of the software services permits a software system of the different entities to react to events triggered by the received RFID data in accordance with entity specific configurations established for the RFID network data service.

Another aspect of the present invention can include a system, method, computer program product and service for supporting RFID data processing applications. In this aspect, a set of network-enabled RFID readers can capture RFID data from RFID tags attached to physical objects. An RFID data mediation service operating upon at least one RFID network data server can synthesize the captured RFID data into categorized RFID data. At least one data processing software application is configured to perform operations upon the categorized RFID data. For example, a remote software application can receive messages when RFID network data changes and react to these messages. In one embodiment, the messages can be provided as part of a software service. In one embodiment, the messages can be provided per a publish/subscribe methodology, based on subscriber specific conditions, rules, and triggers—each of which is subscriber configurable.

### BRIEF DESCRIPTION OF THE SEVERAL VIEWS OF THE DRAWINGS

FIG. 1 is a schematic diagram illustrating a system depicting a RFID data network framework to support processing of RFID data captured over a large domain in accordance with embodiments of the inventive arrangements disclosed herein.

FIG. 1A illustrates the publication of locally-captured RFID data to the RFID data network framework.

FIG. 2 is a flow chart of a method describing the basic functions performed within the RFID data network framework in accordance with an embodiment of the inventive arrangements disclosed herein.

FIG. 3 is an illustrated example for providing inventory control services using RFID data captured by the RFID data network framework in accordance with an embodiment of the inventive arrangements disclosed herein.

### DETAILED DESCRIPTION

The present invention discloses a solution that provides a RFID data network framework for categorizing RFID data captured throughout a corresponding network domain to support real-time or near real-time operation of data processing applications. The RFID data network framework can represent multiple network-enabled RFID readers and RFID network data servers operating within the network domain, a defined geographic region. The RFID data can be contained in the RFID tags attached to various RFID-tagged items, which can move or be moved within the network domain. Applications can run, which react to events depending upon RFID based data changes from the network domain. As RFID-tags items move within proximity of a network-enabled RFID reader, the RFID data can be captured and categorized by a RFID data mediation service. The categorized RFID data can then be stored for later use by requesting data processing applications.

In one embodiment, the network domain can include a data warehouse for RFID data, which is continuously updated as RFID data changes. The applications can access the data warehouse information. In one embodiment, RFID based services can be used as communication intermediaries between the network domain (e.g., the data warehouse of RFID data) and the applications using the services. Services can include publish/subscribe services in one embodiment. In one embodiment, RFID devices can include IP RFID devices, which interact with the network domain, convey data to the networked data warehouse, and/or use RFID services of the network domain (as opposed to proprietary systems that the RFID devices are directly connected to, which is a conventional implementation). The RFID devices may alternatively lack an IP address or other direct network connectively but can be communicatively linked to a computer in communication with the network domain (where the computer is a communication intermediary between the RFID devices and the network domain server). Security mechanisms can ensure RFID data is not accessible by unauthorized users. For example, RFID data can be obscured, made anomalous, and/or encrypted depending on implementation specifics.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

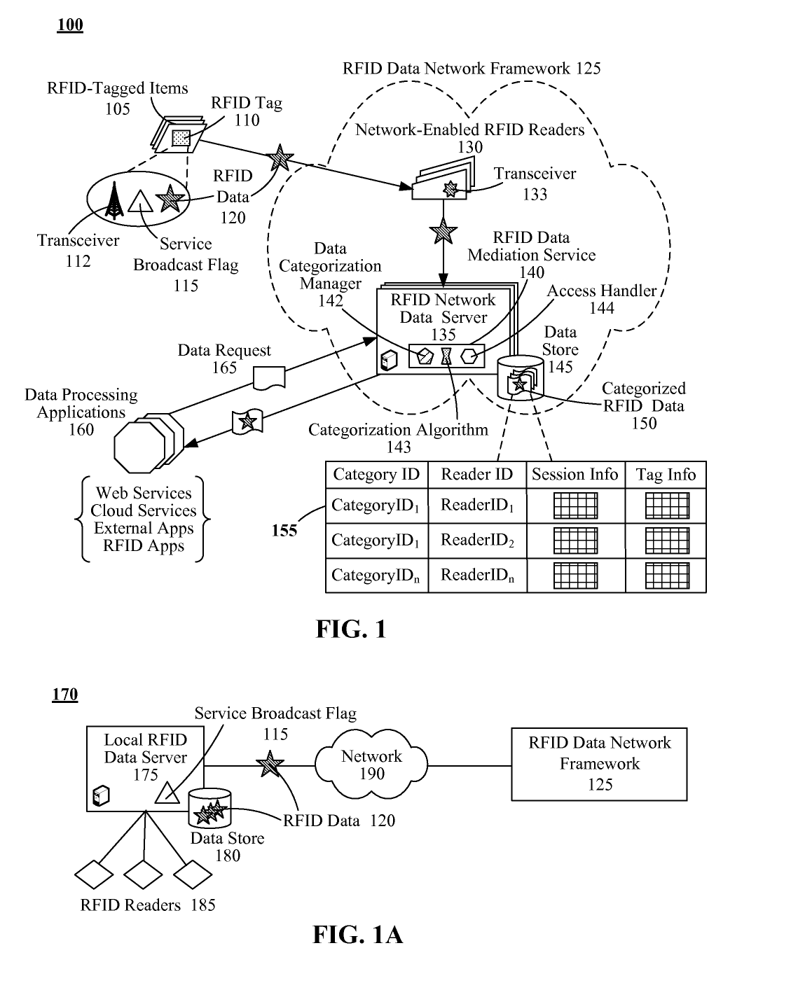

FIG. 1 is a schematic diagram illustrating a system 100 depicting a RFID data network framework 125 to support processing of RFID data 120 captured over a large domain or area in accordance with embodiments of the inventive arrangements disclosed herein. In system 100, RFID data 120 captured by the RFID data network framework 125 can be categorized and provided to a variety of data processing applications 160.

The RFID tag 110 can represent a device attached to a RFID-tagged item 105 configured to transmit stored RFID data 120 using a radio signal. The RFID-tagged item 105 can represent a variety of physical objects, such as mobile computing devices (e.g., mobile phones, toll devices, etc), tagged for-purchase items (books, clothing, etc.) tagged shipping crates, tagged automobiles, and the like. The RFID tag 110 can be fashioned out of various materials and attached to the RFID-tagged item 105 in a variety of ways that support desired functionality parameters for the type of physical object. RFID tags 110 can be active, passive, or semi-active tags.

For example, RFID tags 110 meant to be disposable or for shorter term use such as inventory management can be incorporated into the adhesive labels placed on packages. RFID tags 110 can represent any component where data embedded in a tangible medium is transmitted via RF carrier waves to an RFID reader (e.g., device 130).

The RFID data 120 can represent a variety of information pertinent to the associated RFID-tagged item 105. The RFID data 120 of a RFID tag 110 affixed to a shipping container 105 can include a manifest as well as origination and destination information.

In addition to the RFID data 120, the RFID tag 110 can include a transceiver 112 and a service broadcast flag 115 as well as additional components supporting its operation, such as a physical storage area or battery. Depending upon implementation, the RFID tag 110 can be categorized as passive, receiving power for transmission from a RFID reader, active, having a power source for active transmission, battery-assisted, enabling use of a battery upon signal receipt from a RFID reader, or any other combination/hybrid composition thereof.

The transceiver 112 can represent the means in which the RFID tag 110 transmits the RFID data 120 and service broadcast flag 115 to a network-enabled RFID reader 130. The service broadcast flag 115 can be an indicator to a network-enabled RFID reader 130 as to whether the associated RFID data 120 is to be stored/utilized by the RFID data network framework 125. The service broadcast flag 115 can be hard-coded within the RFID tag 110 (i.e., set by a manufacturer) or can be automatically toggled by a function of the RFID tag 110.

The RFID data network framework 125 can represent the hardware and software necessary for gathering and synthesizing RFID data 120 for meaningful use by data processing applications 160, software programs capable of performing preset data operations. The RFID data network framework 125 can include multiple network-enabled RFID readers 130 operating over a network domain or area and RFID network data servers 135.

As used herein, the term “network domain” can be defined in different way dependent upon context and implementation specifics. Generally, it can represent a geographic region, continuous or not, containing one or more independent entities. The network-enabled RFID readers 130 can be dispersed among the property of the independent entities and/or upon public locations maintained by state or federal government entities. Thus, the network domain within which the RFID data 120 is gathered need not be limited to a single entity and therefore, a single type. The network domain can be a distributed space, such as a computing space of a service oriented architecture (SOA), a cloud computing environment, a J2EE application server space, and the like.

In one embodiment, the network domain can support a geographic area greater than one square mile, such as a sizable neighborhood of a large city or a small town. In another embodiment, the network domain can represent a commercial area containing multiple independent businesses, such as a shopping mall, fairground, or bazaar. One or more geographic regions can be supported by a set of one or more RFID network data servers 135. That is, an M to N relationship can exist between geographic regions (containing RFID readers) and RFID network data servers 135.

In one embodiment, each network domain can include a set of independent properties located over a large geographic area. Functional definitions and divisions can be established for a network domain. For example, a network domain can exist for inventory tracking, which includes sub-domains for specific retail chains (or each retail chain can be defined as its own network domain, regardless of quantity and location of storefronts included in the retail chain).

One example of a network domain can include storefront properties for a bookstore chain (owned by the same or different entities) spread throughout a state. Inventory, sales, and other movements of the books can be tracked based on RFID events throughout the state. Store specific item tracking can be supported by system 100, as can aggregation of RFID data across stores. Regardless, the RFID data from each store 120 and events triggered when RFID tag read events occur can be conveyed to server 135, which implements configurable services able to react to changes in RFID data. This represents a departure from traditional solutions, where RFID data events are handled and processed locally by dedicated (and typically proprietary) combinations of hardware/software.

In system 100, as RFID-tagged items 105 move about the network domain, the associated RFID data 120 can be captured by various network-enabled RFID readers 130. The network-enabled RFID reader 130 can correspond to an electronic device configured to interrogate a complementary RFID tag 110 for its RFID data 120. Using a transceiver 133, the network-enabled RFID reader 130 can transmit data requests via a radio signal that can, in turn, be received by the transceiver 112 of the RFID tag 110. In one embodiment, a network enabled RFID reader 130 can be replaced with a set of one or more RFID readers communicatively linked to a computing device, which is network enabled (i.e., is in communication with server 135).

Due to the wide variety of operating parameters utilized for accessing/encoding RFID data 120 upon RFID tags 110, the network-enabled RFID reader 130 can take a variety of forms dependent upon installation area and breadth of coverage. For example, a RFID data network framework 125 serving the U.S. and Europe would utilize network-enabled RFID readers 130 of the appropriate radio frequency for each disparate area. Readers 130 can include specially tuned devices directed towards obtaining data from a specific type of tag 110. Such readers 130 can include a plug-in or other software module, which is designed to interface with the RFID network data server 135 (e.g., an permit the reader 130 to internally run RFID services, such as publish/subscribe services). Readers 130 can also include general purpose devices able to read a variety of RFID tags 110, which are manufactured and configured to be compatible with the RFID network data server 135. Open (or even proprietary, or a combination of open and proprietary) standards can exist to ensure capability among the tags 110, readers 130, and servers 135.

Additionally, each network-enabled RFID reader 130 can be addressed using version six of the Internet protocol (IPv6). Use of IPv6 can provide a larger addressing pool than that of the current version (IPv4) as well as greater support for Internet service provider (ISP) changes and data security. IPv4 can alternatively be used for addressing readers 130, where a local IP address (as opposed to a global one) can be used per device to conserve IP addresses as needed. Although an IP address can be used as a unique identifier of a reader 130, this is not a requirement of system 100 and other identifiers (including MAC addresses, hardware unique addresses, database ID's linked to a primary key, and the like) can be used.

In another contemplated embodiment, existing RFID readers can be reconfigured into network-enabled RFID readers 130, which may require attachment of a peripheral (including a network interface card (NIC) or WIFI transceiver), or use of an additional computing device (including a processor, memory, bus, NIC, software, and the like).

The RFID data 120 collected by network-enabled RFID readers 130 can be transmitted to a RFID network data server 135. Conveyance of the RFID data 120 to the RFID network data server 135 can utilize a variety of means, such as a mobile telephony (3G, for example) or wireless network (e.g., WIFI, WIMAX, BLUETOOTH, etc.), a wireline network, or a combination of the two depending upon specifics of the network-enabled RFID reader 130. The RFID network data server 135 can represent the hardware and/or software required to store received RFID data 120 and perform the additional functions of the RFID data network framework 125. A variety of configurations utilizing one or more RFID network data servers 135 can be used depending upon implementation requirements and the size of the network domain being covered.

In one embodiment, the network-enabled RFID reader 130 can convey the RFID data 120 to the RFID network data server 135 in real-time or near real-time. In another contemplated embodiment, the RFID data 120 captured by the network-enabled RFID reader 130 can be store upon a computing device (not shown) connected to the network-enabled RFID reader 130 and transmitted as a batch to the RFID network data server 135.

As the amount of RFID-tagged items 105 and network-enabled RFID readers 130 increases in everyday life, the more RFID data 120 can be received by the RFID network data servers 135. However, in its raw format, such a massive quantity of RFID data 120 can be near useless to a data processing application 160. For example, a data processing application 160 concerned with RFID data 120 pertaining to a specific type of tagged item 105 may have to search through tens of thousands of extraneous data records.

This problem can be solved by a RFID data mediation service 140 operating upon the RFID network data server 135. The RFID data mediation service 140 can correspond to a software application configured to manage the volume of received RFID data 120. To do so, the RFID data mediation service 140 can include a data categorization manager 142, a categorization algorithm 143, an access handler 144, and a data store 145 for storing the categorized RFID data 150.

In order to make the captured RFID data 120 more meaningful for data processing applications 160, the data categorization manager 142 of the RFID data mediation service 140 can utilize a categorization algorithm 143 to place each piece of received RFID data 120 into a category that corresponding data processing applications 160 can recognize and handle. Thus, the received RFID data 120 can be synthesized into categorized RFID data 150, allowing a data processing application 160 to issue data requests 165 for only a specific category or a subset of data within a specific category.

The categorization algorithm 143 via the RFID data mediation service 140 can be configured to communicate with registered or known data processing applications 160 in order to determine meaningful data categories. As shown in table 155, the categorized RFID data 150 can be first broken down by ‘CategoryID’, then by ‘ReaderID’. A sub-table containing session information and tag information can then be kept for each combination of ‘CategoryID’ and ‘ReaderID’. Geographic designators of the RFID reader can also be used when categorizing data to limit processed data (e.g., a search space) to a defined geographic region, which can greatly expedite processing.

The categorization information supplied by the data processing applications 160 can also include elements configured by a user of the data processing application 160. For example, a user of an RFID tagged item 195 may, through a Web site, indicate a geographic area for use of the item 105. Thus, RFID data 120 received from network-enabled RFID readers 130 outside of this geographic area can be categorized as “Suspect”.

Alternately, the categorization algorithm 143 can be configured to provide high-level categorization, placing the burden of data refinement to the data processing applications 160 and/or an intermediary service (not shown).

In another contemplated embodiment, the data categories can be implemented as a hierarchy to provide varying levels of granularity. Building upon the above example, the “Suspect” category would also belong to the broader category of “Transactions”.

Once the categorization is complete, the access handler 144 can manage requests for and/or distribution of the categorized RFID data 150 to the data processing applications 160. The access handler 144 can represent the hardware and/or software responsible for controlling access to the categorized RFID data 150. Functions of the access handler 144 can include, but are not limited to, authenticating data requests 165 and/or data processing applications 160, performing publication activities for the categorized RFID data 150 to subscribed data processing applications 160, handling encryption/decryption for transmissions of the categorized RFID data 150, and the like.

Interaction between the RFID data network framework 125 and the data processing applications 160 can utilize a variety of communication methods, including, but not limited to, a service-oriented architecture (SOA), a publish/subscribe paradigm, cloud computing practices, Web service protocols, and the like.

Additionally, the RFID data network framework 125 can receive RFID data 120 captured by a localized or legacy RFID data system, as shown in FIG. 1A. RFID readers 185 of the local/legacy system can capture RFID data 120 for storage in a data store 180 of a local RFID data server 175.

Thus, the local RFID data server 175 of the local/legacy system can be configured using a service broadcast flag 115 to convey its collected RFID data 120 to the RFID data network framework 125 over a network 190. This can allow for correlations to be made between the RFID data 120 captured by the local/legacy system and the RFID data network framework 125.

In another contemplated embodiment, the RFID data network framework 125 can be comprised of multiple RFID data network frameworks 125 arranged hierarchically. That is, a RFID data network framework 125 implemented at a neighborhood-level can pass categorized RFID data 150 up to a RFID data network framework 125 at the city-level, which can pass categorized RFID data 150 up to a RFID data network framework 125 at the state or province level, and so on.

Network 190 can include any hardware/software/and firmware necessary to convey data encoded within carrier waves. Data can be contained within analog or digital signals and conveyed though data or voice channels. Network 190 can include local components and data pathways necessary for communications to be exchanged among computing device components and between integrated device components and peripheral devices. Network 190 can also include network equipment, such as routers, data lines, hubs, and intermediary servers which together form a data network, such as the Internet. Network 190 can also include circuit-based communication components and mobile communication components, such as telephony switches, modems, cellular communication towers, and the like. Network 190 can include line based and/or wireless communication pathways.

As used herein, presented data stores 145 and 180 can be a physical or virtual storage space configured to store digital information. Data stores 145 and 180 can be physically implemented within any type of hardware including, but not limited to, a magnetic disk, an optical disk, a semiconductor memory, a digitally encoded plastic memory, a holographic memory, or any other recording medium. Data stores 145 and 180 can be a stand-alone storage unit as well as a storage unit formed from a plurality of physical devices. Additionally, information can be stored within data stores 145 and 180 in a variety of manners. For example, information can be stored within a database structure or can be stored within one or more files of a file storage system, where each file may or may not be indexed for information searching purposes. Further, data stores 145 and/or 180 can utilize one or more encryption mechanisms to protect stored information from unauthorized access.

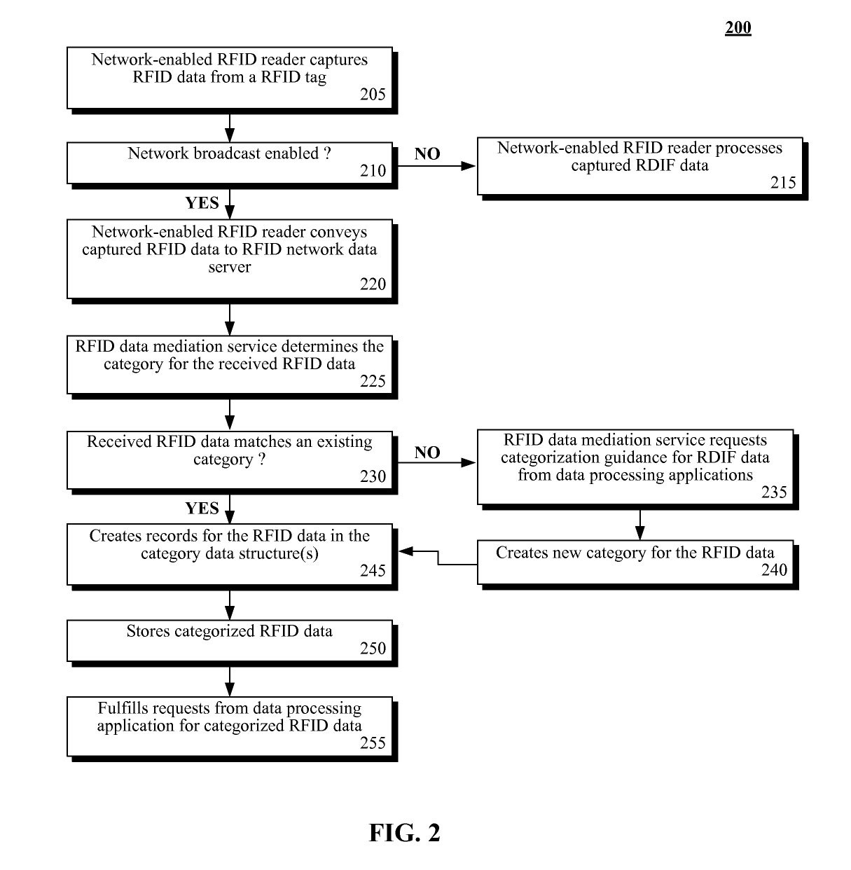

FIG. 2 is a flow chart of a method 200 describing the basic functions performed within the RFID data network framework in accordance with embodiments of the inventive arrangements disclosed herein. Method 200 can be performed within the context of system 100 or having a RFID data network framework configured to provide data processing applications with categorized RFID data.

Method 200 can begin in step 205 where a network-enabled RFID reader can capture RFID data from a RFID tag. In step 210, the network-enabled RFID reader can determine if the captured RFID data can be broadcast to a RFID network data server.

When the captured RFID data is not meant for broadcast to the RFID network data server, normal processing of the captured RFID data can proceed in step 215. That is, the network-enabled RFID reader only performs its standard processing of the RFID data.

For example, the RFID data of a confidential but tagged item can be flagged to not be broadcast to the RFID network data server. Thus, the RFID reader would not pass the captured RFID data to the RFID network data server.

When broadcast to a RFID network data server is indicated, step 220 can be performed where the network-enabled RFID reader can convey the captured RFID data to the RFID network data server. The RFID data mediation service can then determine the category for the received RFID data in step 225. Depending upon the categorization algorithm, step 225 can be enabled to apply more than one category to the received RFID data.

In step 230, it can be determined if the received RFID data matches an existing category used by the RFID data mediation service. Execution of step 230 can involve the performance of calculations based upon previously established rules or guidance from data processing applications that are registered with or subscribed to the RFID data mediation service.

When the received RFID data does not match an existing category, flow of method 200 can proceed to step 235 where the RFID data mediation service can request categorization guidance for the RFID data from data processing applications.

In step 240, the RFID data mediation service can create the new category for the RFID data. Upon completion of step 240 or when the received RFID data matches an existing category, step 245 can be performed where records for the received RFID data can be created in the appropriate category data structures.

The categorized RFID data can then be stored in step 250. In step 255, the RFID data mediation service can fulfill requests from data processing applications for categorized RFID data.

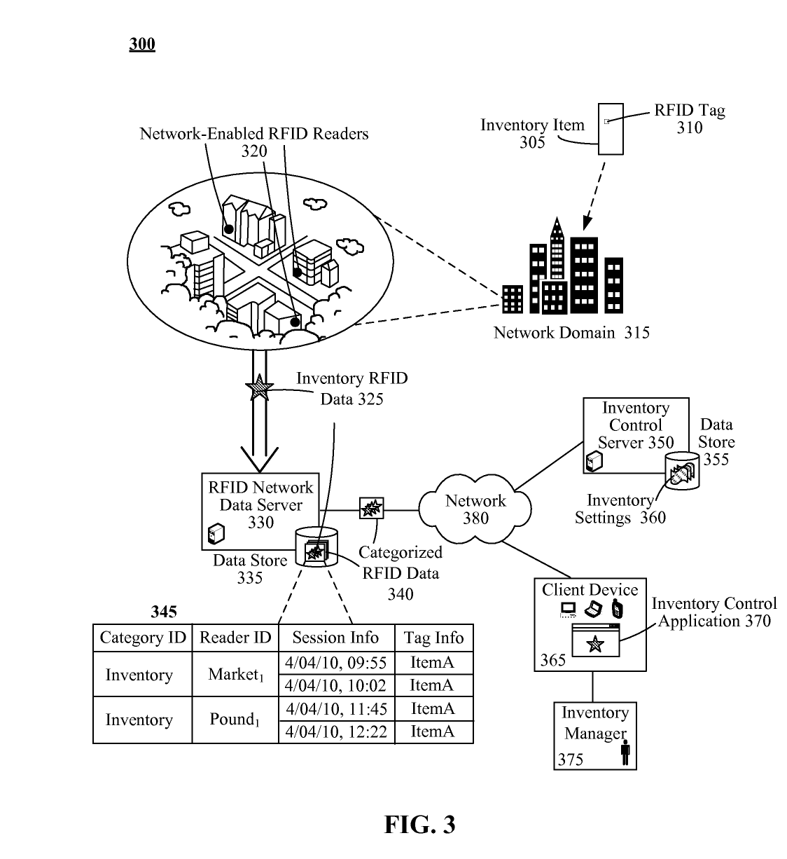

FIG. 3 is an illustrated example 300 for providing inventory tracking services using inventory RFID data 325 captured by the RFID data network framework in accordance with embodiments of the inventive arrangements disclosed herein. Although an inventory item is used in the example 300, any movable RFID tagged item can be substituted in the example 300 and achieve a similar effect as that detailed herein. The illustration shown in FIG. 3 can be utilized within the context of system 100 and/or in conjunction with method 200.

In example 300, an inventory item 305 having a RFID tag 310 can be located within the network domain 315 such as a city. As the inventory item 305 is moved within the network domain 315, various network-enabled RFID readers 320 can capture its RFID data 325.

The RFID data 325 can be sent to a RFID network data server 330. The RFID data 325 can be processed and saved in a data store 335 as categorized RFID data 340. Table 345 can illustrate sample categorized RFID data 340.

In this example, table 345 contains two entries categorized as ‘Inventory’ from two separate network-enabled RFID readers 320, one at a market and one at the pound. The ‘Session Info’ field can contain time and date information regarding the session in which the RFID tag 310 was read. The ‘Tag Info’ field can contain the RFID data 325 received from the RFID tag 310 such as the item name shown in this example 300.

When an inventory manager 375 desires to locate their inventory item 305, the manager 375 can use an inventory control application 370 running on a client device 365. The client device 365 can represent a variety of computing devices capable of running the inventory control application 370 and communicating with the inventory control server 350 over a network 380.

The inventory control application 370 can act as an interface that allows the inventory manager 375 to access functions and/or services provided by the inventory control server 350. The inventory control server 350 can represent the hardware and/or software that processes categorized RFID data 340 for viewing by the manager 375 within the inventory control application 370.

The inventory control server 350 can include a data store 355 for storing inventory settings 360. Inventory settings 360 can represent data specific to a inventory item 305 as well as preferences defined by the inventory manager 375 regarding the inventory item 305. Software functions of the inventory control server 350 as well as the inventory control application 370 can utilize the contents of the inventory settings 360.

For example, the inventory item 305 can have an associated RFID tag 310 scanned when moved near a reader 320. When the inventory control server 350 receives this as categorized RFID data 340, the inventory control server 350 can reference the corresponding inventory settings 360 and send notification (e.g., email, text message) to the inventory manager 375 as to the item's 305 whereabouts.

In another example, the inventory manager 375 can run the inventory control application 370 from a mobile device 365 as they search the network domain 315 for the item 305. The inventory control application 370 can receive updated categorized RFID data 340 as the inventory item 305 is moved, allowing the manager 375 to adjust their search route.

Network 380 can include any hardware/software/and firmware necessary to convey data encoded within carrier waves. Data can be contained within analog or digital signals and conveyed though data or voice channels. Network 380 can include local components and data pathways necessary for communications to be exchanged among computing device components and between integrated device components and peripheral devices. Network 380 can also include network equipment, such as routers, data lines, hubs, and intermediary servers which together form a data network, such as the Internet. Network 380 can also include circuit-based communication components and mobile communication components, such as telephony switches, modems, cellular communication towers, and the like. Network 380 can include line based and/or wireless communication pathways.

As used herein, presented data stores 335 and 355 can be a physical or virtual storage space configured to store digital information. Data stores 335 and 355 can be physically implemented within any type of hardware including, but not limited to, a magnetic disk, an optical disk, a semiconductor memory, a digitally encoded plastic memory, a holographic memory, or any other recording medium. Data stores 335 and 355 can be a stand-alone storage unit as well as a storage unit formed from a plurality of physical devices. Additionally, information can be stored within data stores 335 and 355 in a variety of manners. For example, information can be stored within a database structure or can be stored within one or more files of a file storage system, where each file may or may not be indexed for information searching purposes. Further, data stores 335 and/or 355 can utilize one or more encryption mechanisms to protect stored information from unauthorized access.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for providing categorized RFID data to data processing software applications comprising:
receiving of RFID data by a RFID data mediation service operating upon a RFID network data server;
categorizing the received RFID data based upon contents of at least one of a data store containing previously categorized RFID data and at least one categorization parameter associated with a data processing software application registered with the RFID data mediation service;
storing the categorized RFID data in said data store; and
providing at least one record of categorized RFID data to a corresponding registered data processing software application.

2. The method of claim 1, wherein the RFID network data server implements a publish/subscribe methodology for receiving and providing RFID data received from a plurality of different RFID readers at a plurality of different geographic locations.

3. The method of claim 1, wherein at least a portion of the different RFID readers are owned and operated by different and independent entities, each subscribing to the RFID data mediation service and each sharing RFID information read by their RFID readers with others of the entities through the RFID data mediation service and the RFID network data server.

4. The method of claim 1, wherein the receiving of the RFID data further comprises:
capturing of the RFID data from a RFID-tagged item by a network-enabled RFID reader, wherein said network-enabled RFID reader is located within a network domain defining a bound geographic region; and
conveying the captured RFID data to the RFID network data server.

5. The method of claim 4, wherein the capturing of the RFID data further comprises:
identifying a service broadcast flag within the captured RFID data;
determining a broadcast status from a value of the identified service broadcast flag; and
only when the broadcast status indicates that broadcast is enabled, proceeding to execute the conveyance of the RFID data to the RFID network data server.

6. The method of claim 5, further comprising:
when the broadcast status indicated that broadcast is disabled, negating execution of the conveyance of the RFID data to the RFID network data server.

7. The method of claim 1, wherein the RFID data is received from a plurality of different independent RFID data systems in compliance with an open standard, wherein the RFID network server provides customizable RFID data processing of the received RFID data as software services.

8. The method of claim 1, wherein the categorizing of the RFID data further comprises:
determining an existence of a categorization match to the received RFID data within the previously categorized data; and
when at least one categorization match exists, adding the received RFID data to data structures of the at least one categorization match, wherein said data structures conform to a standardized electronic format.

9. The method of claim 8, further comprising:
when at least one categorization match is nonexistent, requesting categorization guidance for the received RFID data from registered data processing software applications;
upon receipt of said categorization guidance, determining an existence of a match between the categorization guidance and an existing categorization; and
when the categorization guidance matches the existing categorization, proceeding with the addition of the received RFID data to the data structures of the existing categorization.

10. The method of claim 9, further comprising:
when the categorization guidance is disparate from existing categorizations, creating a new categorization and data structures for the categorization guidance within the data store; and
adding the received RFID data to the data structures of the new categorization.

11. The method of claim 1, further comprising:
an entity associated with the RFID network data server processing RFID data received from a plurality of different sources, wherein each of the different sources are independent legal entities from each other;
determining based on entity specific profiles when data change events occur responsive to the processing of the RFID data, which at least one of the different independent legal entities is concerned about as indicated by a corresponding one of the entity specific profiles that was previously configured by an agent of the corresponding one of the different legal entities; and
based on a positive outcome of the determining, conveying at least one message indicating the data change event to at least one of the different independent legal entities, which is able to subsequently perform programmatic actions within an entity specific computer system that is driven by contents of the conveyed at least one message.

12. The method of claim 1, further comprising:
providing software services to a plurality of different entities for a fee, where each of the software services permits a software system of the different entities to react events triggered by the received RFID data in accordance with entity specific configurations established for the RFID network data service.

13. The method of claim 1, further comprising:
receiving RFID data from a plurality of different independent sources, wherein each of the plurality of different sources is selectively compensated for providing the RFID data over a network to the RFID network data server, wherein an operator of the RFID network data server is a legal entity independent of any of the different independent sources.

14. A computer program product comprising a computer readable storage medium having computer usable program code embodied therewith, the computer usable program code comprising:
computer usable program code stored on a tangible storage medium that when executed by a processor is operable to receive RFID data by a RFID data mediation service operating upon a RFID network data server;
computer usable program code stored on a tangible storage medium that when executed by a processor is operable to categorize the received RFID data based upon contents of at least one of a data store containing previously categorized RFID data and at least one categorization parameter associated with a data processing software application registered with the RFID data mediation service;
computer usable program code stored on a tangible storage medium that when executed by a processor is operable to store the categorized RFID data in said data store; and
computer usable program code stored on a tangible storage medium that when executed by a processor is operable to provide at least one record of categorized RFID data to a corresponding registered data processing software application.

15. The computer program product of claim 14, wherein the RFID network data server implements a publish/subscribe methodology for receiving and providing RFID data received from a plurality of different RFID readers at a plurality of different geographic locations

16. A system for supporting RFID data processing applications comprising:
a plurality of network-enabled RFID readers configured to capture a plurality of RFID data from a plurality of RFID tags attached to a plurality of physical objects;
a RFID data mediation service operating upon at least one RFID network data server configured to synthesize the plurality of captured RFID data into categorized RFID data; and
at least one data processing software application configured to perform a plurality of operations upon the categorized RFID data.

17. The system of claim 16, further comprising:
publish/subscribe services for RFID data handled by the system, wherein the public/subscribe services are network services, wherein the publish/subscribe services are provided by software stored in a tangible medium executing on hardware including a processor that handles programmatic instructions of the software.

18. The system of claim 16, wherein the RFID data mediation service further comprises:
a categorization algorithm defining a plurality of rules for categorizing the plurality of RFID data;
a data categorization manager configured to utilize the categorization algorithm to determine at least one data categorization for the plurality of RFID data and store said plurality of RFID data in at least one data structure associated with the at least one data categorization; and
an access handler configured to control access to the categorized RFID data by the at least one data processing software application.

19. The system of claim 16, wherein at least a portion of the network-enabled RFID readers are owned and operated by different and independent entities, each subscribing to the RFID data mediation service and each sharing RFID information read by their RFID readers with others of the entities through the RFID data mediation service and the RFID network data server.

20. The system of claim 16 further comprising:
a plurality of Web services, each implemented in software executing upon a processor, that provide RFID data to subscribers, wherein each of the Web services provide data to subscribers that indicates when RFID data handled by the system changes per subscriber specific rules and conditions.
